(19) United States
(12) Patent Application Publication
(10) Pub. No.: US 2002/0029242 A1
(43) Pub. Date: Mar. 7, 2002

(54) Image editing method and system

(76) Inventor: Satoshi Seto, Kaisei-machi (JP)

Correspondence Address: BIRCH, STEWART, KOLASCH & BIRCH, LLP, P.O. BOX 747, FALLS CHURCH, VA, 22040-0747, US

(21) Appl. No.: 09/760,795

(22) Filed: Jan. 17, 2001

(30) Foreign Application Priority Data
Jan. 17, 2000 (JP) 007272/2000
Jan. 17, 2000 (JP) 007273/2000
Feb. 4, 2000 (JP) 027965/2000
Dec. 28, 2000 (JP) 399715/2000
Dec. 28, 2000 (JP) 399716/2000

(51) Int. Cl. G06F 15/16

(52) U.S. Cl. 709/203; 709/246

(57) ABSTRACT

If, in an image editing system, the user gives a laboratory a command to start editing, the laboratory transfers template data to the personal computer (PC) on the side of the user. If the user queries the laboratory about an editing object by the PC, the laboratory transfers editing information, which represents the editing object, to the PC. In response to this, the user gives a command to edit and transfers edit-command information representing the result of editing to the laboratory. Based on the edit-command information, the laboratory obtains intermediate processed image data by editing the template data and the image data, and transfers this to the PC. Furthermore, the users makes an inquiry about other editing objects, and obtains processed image data by repeating the aforementioned editing process until the process is performed for all the editing objects.

### BACKGROUND OF THE INVENTION

1. Field of the Invention

The present invention relates to an image editing system and a method in which a command to edit an image is made at a client side and, based on this edit command, the image is edited at a server side, and to a computer readable storage medium recording a program for causing a computer to carry out the image editing method.

2. Description of the Related Art

A digital photo-service system is known as applying wide variety of digital photo-services related to photographs, such as digitizing photographic images photographed by a user and storing in an image server, recording the digitized images on a recordable compact disc (CD-R) and providing to the user, receiving an order for an additional print, etc. As a form of such a system, there has also been proposed a network photo-service system wherein user's digital images are archived (or registered) in the system of a service provider and a print order, etc., are accepted through a network such as the Internet, etc.

It has been considered that when providing digital photo-services to users, such a network photo-service system is capable of providing a great variety of services, such as an order for an additional print, electronic mail accompanied by a photographic image, downloading of image data, etc., by installing a server computer with scanners, printers, and large-capacity disks (hereinafter referred to as an “image server”) in a large collection and delivery laboratory so that a photograph taken by the user can be stored in the image server as image data and the user can access the image server through a network. To give such services, the laboratory obtains image data representing user's images and also has editor software for applying a multiplicity of commands to edit low-resolution image data, which represents the scaled-down image from a user's image, template data, and image data. On the other hand, the user accesses the image server of the laboratory at his computer by the use of application software such as a Web browser, etc.; downloads low-resolution image data, editor software, and template data; edits the image by the use of the editor software; and transfers the result of editing to the laboratory as edit-command information. As the editor software is the same as the software in the laboratory which performs an editing process, the user can perform the same editing process as the process performed in the laboratory, using this editor software. Based on the edit-command information transferred from the user, the laboratory is capable of obtaining processed image data by applying various image processes, such as a process of generating an additional print and a postcard with a photograph, a process of generating an album, a process of synthesizing images, a trimming process, etc., and is capable of taking appropriate action, such as transferring the processed image data to the user, informing the user that processing has ended, etc.

However, the editor software that is downloaded into the personal computer (PC) of the user is the same as the editor software of the image server and relatively large in volume. Because of this, the downloading operation is time-consuming, and therefore, burdens to the user such as a connection charge, etc., are great. In addition, the same editor software is present in the PCs of users and the image server, and because of this, every time the editor software is revised, it will be necessary to inform the users to that effect. Therefore, the management cost for the software company increases. Furthermore, if the software is revised and processing becomes complicated, there is a possibility that the processing capacity of the PCs on the user side will become insufficient. In that case it will take a lot of time to process an edit command.

In addition, the processed image data has the same resolution as the original data, unlike low-resolution image data for performing editing, and therefore, transferring this to the user is time-consuming. On the other hand, the applicant of this application has proposed an image editing system wherein a user gives only an edit command without downloading editor software to the user's PC and the results of editing are transferred in sequence from an image server to the user. However, since in such a system the intermediate processed image data processed up to an intermediate stage is transferred to the user for each edit command, it takes a lot of time to transfer data if it is large in data amount, and consequently, the editing process cannot be efficiently performed.

There are cases where, in the above-mentioned network photo-service system, the user inserts characters into an image. Also, depending on template type, the user can insert desired characters at a predetermined position on the template. In this case, the user generates characters to be inserted into an image, fonts, and the layout as edit-command information by the use of low-resolution image data, and transfers this information to the laboratory. Based on the transferred edit-command information, in the laboratory an image with desired characters inserted therein can be generated by inserting the specified characters into the image data, archived in the laboratory, at the specified layout with the specified fonts.

However, the user has installed various applications into the PC and therefore has various fonts attendant to the applications. Because of this, there are cases where the fonts which are used by the user do not match the fonts usable in the laboratory. In those cases, even if characters are specified with the font that only the user has, in the laboratory they cannot be inserted with that font. Therefore, the user can use only fonts installed in the laboratory, resulting in a reduction in the degree of freedom of character editing.

### SUMMARY OF THE INVENTION

The present invention has been made in view of the disadvantages found in the prior art. Accordingly, it is an object of the present invention to provide an image editing method and an image editing system which are capable of reducing the image editing load on users and the cost for managing editor software, and a computer readable storage medium recording a program for causing a computer to carry out the image editing method.

Another object of the invention is to provide an image editing method and an image editing system which are capable of efficiently transferring processed image data to users, and a computer readable storage medium recording a program for causing a computer to carry out the image editing method.

Still another object of the invention is to provide an image editing system, an image-editing command method and unit, and an image editing method and unit which are capable of performing an operation of inserting characters into an image with fonts desired by users, and a computer readable storage medium recording a program for causing a computer to carry out these methods.

In accordance with the first invention, there is provided an image editing method that is performed in an image editing system equipped with a client, which has an edit-command unit for applying a command to edit image data, and an image server, connected with the client through a network, which has an editing unit for obtaining processed image data by editing the image data in response to the edit command from the edit-command unit, the image editing method comprising:

a first step of accepting an edit-start command and, in response to the edit-start command, commanding the image server to transfer editing data, having at least one editing object, which contains the image data, at the edit-command unit, and of transferring the editing data to the client at the image server;

a second step of querying the image server about one editing object for obtaining the processed image data in accordance with the editing data, at the edit-command unit;

a third step of transferring editing information, which represents the one editing object corresponding to the inquiry, to the client, at the editing unit;

a fourth step of generating edit-command information which represents a command to edit the editing object, in accordance with the editing information and also transferring the edit-command information to the image server, at the edit-command unit;

a fifth step of obtaining intermediate processed image data by applying an editing process on the editing data in accordance with the edit-command information and also transferring the intermediate processed image data to the client, at the editing unit; and

a sixth step of repeating the second through the fifth steps, until the edit-command information is transferred for an editing object desired and the processed image data is obtained.

The words “editing data” may be only image data, or template data representing a template which combines with image data, or synthesized data of image data and template data. It is preferable that the editing data which is transferred from the image server to the client be data, reduced from the original data, which represents a low-resolution image, data with enhanced compressibility, data with reduced colors(i.e., data given a color reducing process), or the like, in order to reduce the data amount.

The “reduction” is intended to mean that the vertical and horizontal sizes of an image presented by the editing data are reduced. Note that in the case of reduction, it is preferable not to change the aspect ratio. The process of “enhancing compressibility” may be a known compression process, such as a JPEG compression method, a method of splitting data according to resolution levels and compressing the split data for each resolution level, and the like. The “color reducing process” is intended to mean, for example, that in the case where the number of colors of the editing data is 32 bits, it is reduced to 256 colors, or is intended to mean to perform dithering, etc. Such a data compressibility that does not over deteriorate the picture quality of the editing data (e.g., in the case of JPEG, about 1/20) is preferred, because, if the compressibility is made too high, the picture quality of the editing data at the client side will be reduced. In addition, in the case of large-capacity networks, the editing data may be transferred without reducing the amount of data. This enables the client to display editing data with high picture quality and perform an editing process in detail. Furthermore, editing data may be transferred so that the client can select the amount of the data.

In cases where there is only image data, the words “editing object” represent the contents of image processing which can be applied to the image data. More specifically, in addition to a red-eye process, a sharpness enhancing process, a color converting process, a trimming process, and a scaling process, the editing object represents a process of applying an image a white edge, a process of forming a wave pattern in an image, etc. In cases where the editing data is template data or synthesized data, the editing object, in addition to the above-mentioned processes, represents a region into which user's images, or images such as clip art, etc., are inserted, or a region into which characters are inserted. The editing data contains at least one of the editing objects.

The expression “query one editing object” means to query the editing unit about what kind of editing object is contained in the obtained editing data. For instance, in the case where the editing data is only image data, it means to query the contents of a process that can be applied to this image data. Also, in the case where the editing data is template data or synthesized data, it means to query the position of a region into which images or characters are inserted, in addition to the contents of a process that can be applied to this image data. Note that an inquiry about the position at which images or characters are inserted can be made by clicking on a predetermined position on the editing data displayed on the screen. Also, the words “one editing object” mean to query only one editing object even when the editing data contains a plurality of editing objects.

The expression “editing information representing an editing object” specifically represents the editing object queried from the edit-command unit. For example, in the case where the editing data is image data alone, the editing information represents a list of processes, such as a red-eye process, a sharpness enhancing process, etc., which can be applied to the image data in accordance with an inquiry about an editing object. Also, in the case where the editing data is template data or synthesized data, the editing information, in addition to the contents of a process to be applied to image data, represents the coordinate values of a position at which images or characters are inserted, the coordinate values representing a region to which image processing can be applied, etc.

The “edit-command information” represents the contents of a process that is applied to an editing object queried. For instance, in the case where the editing data is only image data, the edit-command information represents a process selected from a list of processes represented by the editing information. Also, in the case where the editing data is template data or synthesized data, the editing-command information represents the position at which images or characters are inserted, and the region to which image processing is applied, and represents image size to be inserted, characters to be inserted, fonts, etc. While there are cases where the information representing the inserting position is varied by the user, there are cases where the original data remains unchanged. The edit-command information, therefore, also contains information indicating that no process is applied.

The aforementioned intermediate processed data represents data obtained by processing the editing data in accordance with the editing information corresponding to an editing object queried. Note that it is preferable that the intermediate processed image data be reduced in data amount by enhancing the reduced compressibility, or by applying a color reducing process, in order to reduce the data amount. The “reduction” means that the vertical and horizontal sizes of an image presented by the intermediate processed image data are reduced. Note that in the case of reduction, it is preferable not to change the aspect ratio. The process of “enhancing compressibility” may be a known compression process, such as a JPEG compression method, a method of splitting data according to resolution levels and compressing the split data for each resolution level, and the like. The “color reducing process” is intended to mean, for example, that in the case where the number of colors of the intermediate processed data is 32 bits, it is reduced to 256 colors, or is intended to mean to perform dithering, etc.

The expression “repeat the second through the fifth steps” means that when there is only one editing object (e.g., when the editing process is a trimming process), the steps are performed once, because the intermediate processed image data, obtained by applying the steps once, becomes the processed image data. When there are a plurality of editing objects, the second through the fifth steps are repeated until processing ends for an editing object desired. Note that the editing object desired may be all editing objects, or an arbitrary editing object of a plurality of editing objects.

Note that when the editing process applied to the intermediate processed image data is not the desired process, it is necessary to perform a process again. Thus, in the case where a process to one editing object is desired to be repeated, the second through the fifth steps can be repeated.

In accordance with the first invention, there is also provided an image editing system comprising:

a client having an edit-command unit for applying a command to edit image data;

an image server, connected with the client through a network, which has an editing unit for obtaining processed image data by editing the image data in response to the edit command from the edit-command unit;

the edit-command unit having first means for accepting an edit-start command and, in response to the edit-start command, commanding the image server to transfer editing data, having at least one editing object, which contains the image data; second means for querying the image server about one editing object for obtaining the processed image data, based on the editing data transferred from the image server in accordance with the command to transfer the editing data; and third means for generating edit-command information which represents a command to edit the editing object, based on the editing information transferred from the image server in accordance with the inquiry about the editing object, and for transferring the edit-command information to the image server;

the editing unit having first means for transferring the editing data to the client in response to the command to transfer the editing data; second means for transferring editing information, which represents an editing object corresponding to the inquiry, to the client; and third means for obtaining intermediate processed image data by applying an editing process on the editing data, based on the edit-command information, and for transferring the intermediate processed image data to the client; and

means for repeatedly carrying out the steps carried out in the second and third means of the edit-command unit and the first, second, and third means of the editing unit, until the edit-command information is transferred for an editing object desired and the processed image data is obtained.

Note that in a p referred form of the first image editing system according to the present invention, the aforementioned third means is means for compressing and transferring the intermediate processed image data to the client.

A first storage medium according to the present invention is a computer readable storage medium recording a program for causing a computer to carry out the first image editing method of the present invention, wherein the program has

a first procedure of accepting an edit-start command and, in response to the edit-start command, commanding the image server to transfer editing data, having at least one editing object, which contains the image data;

a second procedure of querying the image server about one editing object for obtaining the processed image data, based on the editing data transferred from the image server in accordance with the command to transfer the editing data;

a third procedure of generating edit-command information which represents a command to edit the editing object, based on the editing information transferred from the image server in accordance with the inquiry about the editing object, and of transferring the edit-command information to the image server; and

a fourth procedure of repeating the second and third procedures, until the edit-command information is transferred for an editing object desired and the processed image data is obtained.

A second storage medium according to the present invention is a computer readable storage medium recording a program for causing a computer to carry out the first image editing method of the present invention, wherein the program has

a first procedure of transferring the editing data to the client in response to the command to transfer the editing data;

a second procedure of transferring editing information, which represents an editing object corresponding to the inquiry, to the client;

a third procedure of obtaining intermediate processed image data by applying an editing process on the editing data, based on the edit-command information, and of transferring the intermediate processed image data to the client; and

a fourth procedure of repeating the first, second, and third procedures, until the edit-command information is transferred for an editing object desired and the processed image data is obtained.

Note that in a preferred form of the second storage medium according to the present invention, the aforementioned third procedure is a procedure of compressing and transferring the intermediate processed image data to the client.

An edit-command unit according to the present invention is an edit-command unit in an image editing system equipped with a client, which has the edit-command unit for applying a command to edit image data, and an image server, connected with the client through a network, which has an editing unit for obtaining processed image data by editing the image data in response to the edit command from the edit-command unit, the edit-command unit comprising:

first means for accepting an edit-start command and, in response to the edit-start command, commanding the image server to transfer editing data, having at least one editing object, which contains the image data;

second means for querying the image server about one editing object for obtaining the processed image data, based on the editing data transferred from the image server in accordance with the command to transfer the editing data;

third means for generating edit-command information which represents a command to edit the editing object, based on the editing information transferred from the image server in accordance with the inquiry about the editing object, and for transferring the edit-command information to the image server; and

fourth means for repeatedly carrying out the steps carried out in the second and third means, until the edit-command information is transferred for an editing object desired and the processed image data is obtained.

An editing unit according to the present invention is an editing unit in an image editing system equipped with a client, which has an edit-command unit for applying a command to edit image data, and an image server, connected with the client through a network, which has the editing unit for obtaining processed image data by editing the image data in response to the edit command from the edit-command unit, the editing unit comprising:

first means for transferring the editing data to the client in response to the command to transfer the editing data; the editing data including the image data and also having at least one editing object;

second means for transferring editing information, which represents an editing object corresponding to the inquiry, to the client;

third means for obtaining intermediate processed image data by applying an editing process on the editing data, based on the edit-command information which represents a command to edit said editing information, and for transferring the intermediate processed image data to the client; and

fourth means for repeatedly carrying out the steps carried out in the first, second, and third means, until the edit-command information is transferred for an editing object desired and the processed image data is obtained.

Note that in a preferred form of the editing unit according to the present invention, the aforementioned third means is means for compressing and transferring the intermediate processed image data to the client.

According to the first invention, the edit-command unit in the client (PC) first accepts an edit-start command made by the user. If there is this edit-start command, the edit command unit commands an image server to transfer editing data. In response to the edit-start command, the image server transfers the editing data to the client (first step). If receiving the editing data, the edit-command unit queries the image server about one editing object for obtaining the processed image data (second step). The editing unit transfers editing information, which represents the one editing object corresponding to the inquiry, to the client (third step). The edit-command unit generates edit-command information which represents a command to edit the editing object, in accordance with the editing information and also transfers this to the image server (fourth step). The editing unit obtains intermediate processed image data by applying an editing process on the editing data in accordance with the edit-command information and also transfers the intermediate processed image data to the client (fifth step). Finally, when there are other editing objects desired to be processed, processed image data is obtained by repeating the second through the fifth steps until processing ends for an editing object desired (sixth step).

Thus, in the first embodiment, the user gives only a command to edit each editing object by the edit-command unit and transfers the edit-command information representing the contents of each command to the image server. Therefore, all that is required is that the edit-command unit has only simple software for generating the edit command information, and there is no need to prepare the same editor software as the editing unit. Therefore, as the client does not need to download large-volume editor software, burdens to the user, such as a communication charge, etc., can be reduced. In addition, since the software that is carried out by the client is simple, the edit-command unit is capable of applying an edit command even if the processing capacity is small. For this reason, portable information terminals, portable telephones, mobile computers, etc., are also capable of applying an edit command. Furthermore, because all that is required is that only the editing unit of the image server has the editor software, the need to manage the versions of software being used by all users is eliminated. This can reduce the version management cost for the software company.

In addition, the time for transferring the intermediate processed image data can be shortened by compressing and transmitting the intermediate processed data to the client.

A second image editing method according to the present invention is an image editing method that is performed in an image editing system equipped with a client, which has an edit-command unit for applying a command to edit image data, and an image server, connected with the client through a network, which has an editing unit for obtaining processed image data by performing an editing process on the image data in response to the edit command from the edit-command unit and transfers predetermined image data related to the image data to the client, the image editing method comprising the steps of:

generating low-volume data smaller in a data amount than the predetermined image data; and

transferring the low-volume data to the client.

The “editing process” in the above-mentioned second image editing method represents image processing which can be applied to image data. More specifically, in addition to a red-eye process, a sharpness enhancing process, a color converting process, a trimming process, and a scaling process, the editing process represents a process of applying an image a white edge, a process of forming a wave pattern in an image, etc. In the case where the editing data is template data, or synthesized data of user image data and template data, the editing process, in addition to the above-mentioned processes, represents a process of inserting images, such as user's images and clip arts, or characters, into the template.

The “low-volume data” is used for reducing the data amount of predetermined image data that is transferred from the image server to the client. The low-volume data may employ data, scaled down from the predetermined image data, which represents a low-resolution image, data with enhanced compressibility, data with reduced colors, etc.

In the second image editing method according to the present invention, the predetermined image data may be any one among image data before the editing process is applied, image data subjected to an editing process up to an intermediate stage, and the aforementioned processed image data.

The expression “image data subjected to an editing process up to an intermediate stage” means image data generated when the process of combining template data and a user's image is performed, as described later. First, the image server transfers template data and synthesized data to the client. In response to this, the client queries the image server about editing objects, such as the contents of a process to be applied to the image data, the position of a region into which images and characters are inserted, etc. In response to the inquiry about these editing objects, the image server transfers editing information representing the editing objects (the contents of a process and the position of a region into which images or characters are inserted) to the client. Based on this editing information, the client generates edit-command information, which represents the contents of a process to be applied to the editing object queried, to the image server. Based on the edit-command information, the image server gives a command to edit the image data. Note that even when there are a plurality of editing objects, an inquiry is made by the client for each editing object. Because of this, the data obtained by completing the editing process for one editing object is the data that has not been processed for an editing object desired. In the present invention, the data that has not been processed for an editing object desired is taken to be “image data subjected to an editing process up to an intermediate stage.”

In a preferred form of the second image editing method according to the present invention, the predetermined image data is transferred to the client, following the low-volume data.

In another preferred form of the second image editing method according to the present invention, the data amount of the low-volume data is varied according to a loaded state of the network.

The expression “data amount is varied according to a loaded state of the network” means that the greater the load on the network, the smaller the data amount of the low-volume data. More specifically, the data amount of the low-volume data can be reduced by enhancing compressibility, making resolution lower, or reducing the number of colors.

In still another preferred form of the second image editing method according to the present invention, the low-volume data is composed of a plurality of data reduced in stages in data amount and is transferred to the client in order from the data having a smaller data amount.

In this case, it is preferable to suspend transfer of the low-volume data in response to a command from the client. It is also preferable to restart transfer of the low-volume data in response to a command from the client.

The second image editing system according to the present invention is an image editing system comprising:

a client having an edit-command unit for applying a command to edit image data;

an image server, connected with the client through a network, which has an editing unit for obtaining processed image data by performing an editing process on the image data in response to the edit command from the edit-command unit and transfers predetermined image data related to the image data to the client;

wherein the image server has means for generating low-volume data smaller in data amount than the predetermined image data, and transfers the low-volume data to the client.

In a preferred form of the second image editing system according to the present invention, the predetermined image data is anyone among image data before the editing process is applied, image data subjected to an editing process up to an intermediate stage, and the aforementioned processed image data.

In another preferred form of the second image editing system according to the present invention, the image server is further equipped with means for transferring the predetermined image data to the client, following the low-volume data.

In still another preferred form of the second image editing system according to the present invention, the image server is further equipped with means for varying the data amount of the low-volume data according to a loaded state of the network.

In a further preferred form of the second image editing system according to the present invention, the means for generating low-volume data is means for generating the low volume data so that it is composed of a plurality of data reduced in stages in data amount, and transfers the low-volume data to the client in sequence from the data having a smaller data amount.

In this case, it is preferred that the image server be further equipped with means for suspending transfer of the low-volume data in response to a command from the client. It is also preferred that the image server be further equipped with means for restarting transfer of the low-volume data in response to a command from the client.

Note that a program for causing a computer to carry out the second image editing method of the present invention may be recorded on a computer readable storage medium and provided.

Thus, according to the second embodiment, if predetermined image data is generated at the editing unit of the image server, low-volume data smaller in data amount than the predetermined image data is generated and transferred to the client. Because of this, transfer time can be reduced, compared with the case of transferring the predetermined image data.

In the case where the predetermined image data is the image data subjected to an editing process up to an intermediate stage, it is necessary to transfer the data at each stage to the client. However, the data that is transferred to the client is low in capacity, and therefore the transfer time can be reduced. With this reduction, the editing process can be efficiently performed.

In addition, the data amount of the low-volume data is reduced according to the loaded state of the network. Therefore, when the load on the network is great, low-volume data smaller in data amount is transferred. This makes it possible to transfer data efficiently.

Furthermore, the low-volume data is composed of a plurality of data reduced in stages in data amount. If the low-volume data is transferred in sequence from the data having smaller data amount, data lower in capacity is displayed in sequence to the client.

If transfer of the low-volume data is suspended in response to a command from the client, the client can perform the next process immediately, because the transfer can be stopped when the contents of the low-volume data are found, without waiting for transfer of all data. In addition, transfer of the low-volume data can be restarted after suspension, so the user can receive the low-volume data processed up to a desired stage.

In accordance with the present invention, there is provided a third image editing system comprising:

a client having an image-editing command unit for applying a command to edit image data representing a user's image; and

a server, connected with the client through a network, which has means for archiving the image data and low-resolution image data scaled down from the image data and edits the image data;

editing information required for editing the image data which contains the low-resolution image data being transferred from the server to the client;

an operation of editing the low-resolution image data being performed at the client;

the result of editing being transferred to the server as edit-command information;

processed image data being obtained by editing the image data according to the edit-command information at the server;

wherein, when applying a command to insert a character image, which represents characters, into the user's image, the image-editing command unit generates character image data representing a character image of the approximately the same resolution as the user's image and transfers the character image data and the edit-command information to the server; and

the image editing unit obtains the processed image data by inserting the character image into the user's image, based on the edit-command information and the character image data.

The “editing information required for editing” contains at least low-resolution image data. The editing information may also contain template data representing a template which is combined with image data, editor software required for applying an edit command, etc. It is preferable that the template data which is transferred from the server to the client be low-resolution data scaled down from the original data in order to reduce the data amount.

The “edit-command information” in the third image editing system is information obtained at the client by the use of editor software and represents the content of a process applied to image data and the contents of an editing process, such as an inserting position with respect to a template, image size, etc., which is applied to image data to obtain processed image data. Because the character image data in the third invention is generated at the client, the edit-command information contains α-channel information representing the position at which the character image data is inserted and the relationship of transparency between the user's image and the character image.

An image-editing command unit according to the present invention is an image-editing command unit in the third image editing system of the present invention, the image-editing command unit comprising means which, when applying a command to insert a character image, which represents characters, into the user's image, generates character image data representing a character image of the approximately the same resolution as the user's image and transfers the character image data and the edit-command information to the server.

An image-editing command unit according to the present invention is an image editing unit for editing the image data in accordance with the edit-command information obtained in the image-editing command unit of the present invention, the image editing unit comprising means for obtaining processed image data by inserting a character image into a user's image, based on the edit-command information and character image data.

An image-editing command method according to the present invention is an image-editing command method in the third image editing system of the present invention, the image-editing command method comprising the steps of, when applying a command to insert a character image, which represents characters, into the user's image, generating character image data representing a character image of the approximately the same resolution as the user's image, and transferring the character image data and the edit-command information to the server.

A third image editing method according to the present invention is an image editing method of editing the image data in accordance with the edit-command information obtained in the image-editing command method of the present invention, the image editing method comprising the step of obtaining processed image data by inserting the character image into the user's image in accordance with the edit-command information and the character image data.

Note that a program for a computer to carry out the image-editing command method and third image editing method of the present invention may be recorded on a computer readable storage medium and provided.

According to the third invention, when applying a command to insert a character image representing characters into an image which is represented by image data, the image-editing command unit of the client generates character image data representing a character image of the approximately the same resolution as the image which is represented by the image data archived in the server, and transfers this to the server. Based on this character image data, the image editing unit of the server obtains processed image data by inserting the characters into the image. Therefore, even if the server does not have the fonts desired by the user, characters generated with the desired fonts can be included in the image, and consequently, the degree of freedom of editing can be enhanced.

### BRIEF DESCRIPTION OF THE DRAWINGS

The present invention will be described in further detail with reference to the accompanying drawings wherein:

FIG. 1 is a block diagram showing an image editing system constructed according to a first embodiment of the present invention;

FIG. 2 is a flowchart showing the operation of the first embodiment;

FIG. 3 is a diagram showing a template employed in the first embodiment;

FIG. 4 is a diagram showing a template with sample images and characters inserted therein;

FIGS. 5 and 6 are diagrams showing how the region A1 shown in FIG. 4 is edited;

FIG. 7 is a diagram showing the state in which editing of the region A1 has been completed;

FIG. 8 is a diagram showing the state in which editing of the region A2 shown in FIG. 4 has been completed;

FIG. 9 is a diagram showing the state in which editing of the region A3 shown in FIG. 4 has been completed;

FIG. 10 is a block diagram showing an image editing system constructed according to a second embodiment of the present invention;

FIG. 11 is a flowchart showing the operation of the second embodiment;

FIG. 12 is a block diagram showing an image editing system constructed according to a third embodiment of the present invention;

FIG. 13 is a flowchart showing the operation of the third embodiment;

FIG. 14 is a diagram showing a template employed in the third embodiment;

FIG. 15 is a diagram showing the template after editing ends; and

FIG. 16 is a diagram showing character image data.

### DESCRIPTION OF THE PREFERRED EMBODIMENTS

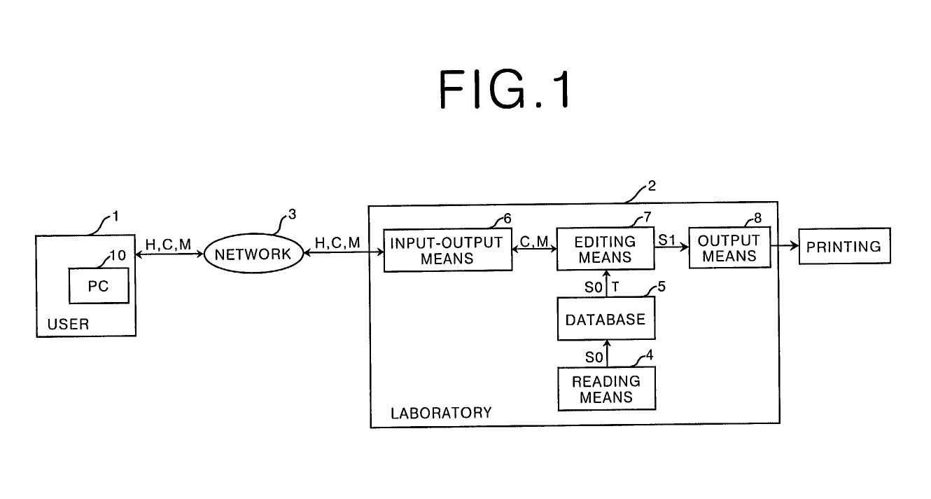

Referring now in greater detail to the drawings and initially to FIG. 1, there is shown an image editing system in accordance with a first embodiment of the present invention. In the image editing system, a user 1 and a laboratory 2 are connected through a network 3 so that the transfer and reception of data can be performed therebetween.

The user 1 has a PC 10 as a client which includes an edit-command unit so that it can transfer and receive data between it and the laboratory 2 through the network 3. In addition, the software for generating edit-command information H is installed in the PC 10, as described later. However, this software is simpler than the software for performing an editing process in an editing means 7 to be described later.

The laboratory 2 is a system as an imager server which carries out printing. It is equipped with reading means 4 for obtaining high-resolution image data S0 by reading out an image from the film brought by the user 1; a database 5 for achieving the read image data S0; input-output means 6 for accepting the edit-command information H from the PC 10 and transferring various kinds of data to the PC 10; the editing means 7 for obtaining processed image data S1 by editing the image data S0, based on the edit-command information H; and output means 8 for printing the processed image data S1. Note that template data T (hereinafter also represented as template T) representing a template for generating a postcard in combination with an image from the user 1, and data representing clip art that are inserted into the template T, are archived in the database 5.

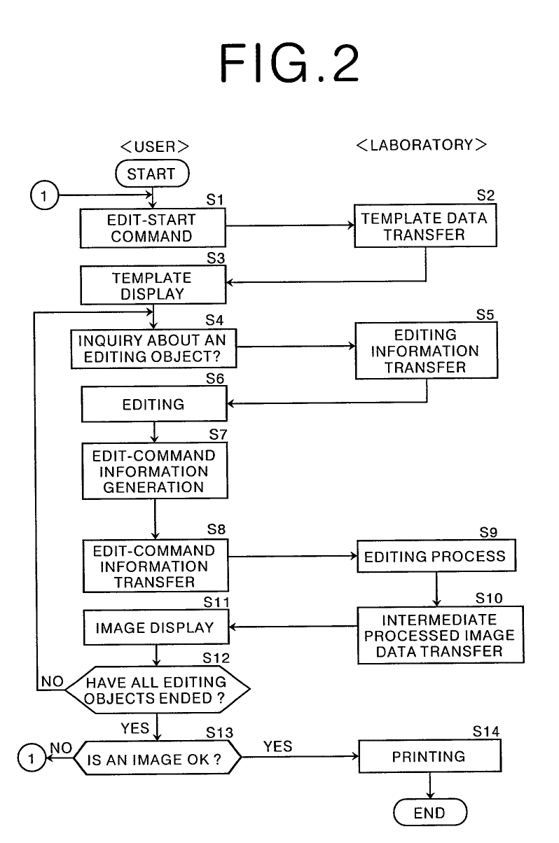

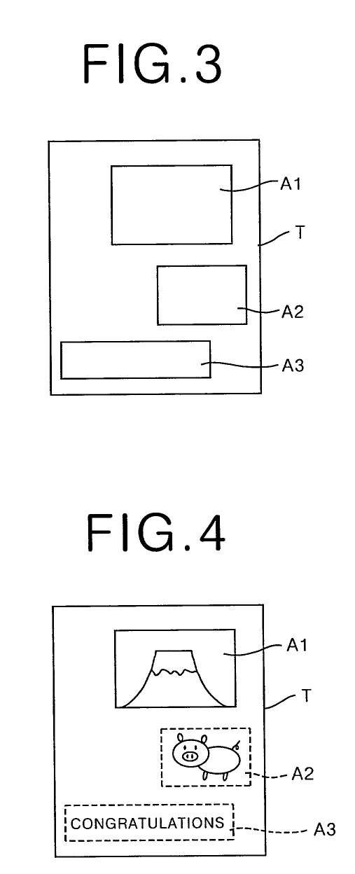

Now, the operation of the first embodiment will be described in detail with reference to FIG. 2. Assume that an image from the user 1 has already been read out by the reading means 4 and archived in the database 5. Also, assume that the first embodiment performs a process of obtaining a processed image by inserting the user's image into region A1 in the template T shown in FIG. 3, a clip art in the region A2, and characters in the region A3. Furthermore, thumbnail images representing a plurality of template data T and clip art data, archived in the database 5, and a thumbnail image for the user' image have already been transferred to the PC 10 of the user 1. First, the user 1 transfers a command to start editing of the user's image to the laboratory 2 by the PC 10 (step S1). As the thumbnail images for a plurality of the template data T archived in the database 5 have previously been transferred to the PC 10, the user 1 selects a desired template from the thumbnail images and transfers an edit-start command to the laboratory 2, whereby a command to start editing is made.

If the laboratory 2 receives the edit-start command, the editing means 7 reads out the template data T representing the selected template from the database 5, and the template data T is transferred to the PC 10 of the user 1 via the input-output means 6 (step S2). Here, assume that as shown in FIG. 4, a sample image, a sample clip art, and sample characters have been inserted into the regions A1 to A3 in the selected template. If receiving the template data T, the PC 10 displays this (step S3). Then, the user 1 confirms the displayed template and queries the laboratory 2 about one of the editing objects (step S4) The inquiry about this editing object is made by clicking on a desired region in the template displayed on the PC 10. In the first embodiment the region A1 is first clicked on.

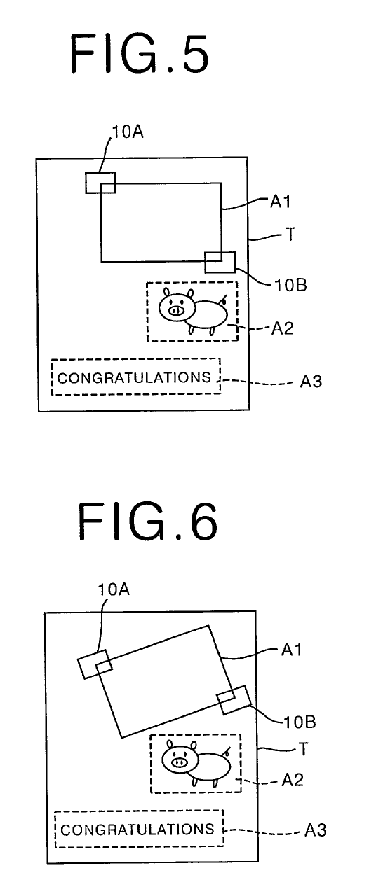

If the laboratory 2 receives the inquiry about the editing object, the editing means 7 transfers editing information, corresponding to the queried editing object, to the PC 10 (step S5) In the first embodiment, the coordinate values (e.g., the coordinate values for the upper left corner and lower right corner of the region A1) representing the range of the region A1 are transferred as the editing information. If receiving the editing information, the user 1 starts the editing of the region A1 (step S6) When the editing information is received, handles 10A, 10B for changing the shape of the region A1 are displayed on the region A1 in the template, as shown in FIG. 5A. The user 1 can scale up, scale down, or rotate the region A1 by manipulating the handles 10A, 10B. It is preferable that when scaling the region A1 up or down, the aspect ratio be archived. In the first embodiment the region A1 is inclined as shown in FIG. 6 on the other hand, since the thumb nail image for user's image has previously been transferred to the PC 10, the user 1 selects the user's image that is inserted into the region A1, inputs the file name to the PC 10, and ends editing, for example, by depressing a return key.

If editing ends, edit-command information H is generated (step S7). This information H is transferred to the laboratory 2 (step S8). The edit-command information H contains information representing the position of the region A1 after change and the file name of the user's image to be inserted. Because the region A1 in the first embodiment has been rotated, the coordinate values for the four corners of the region A1 after change are contained in the edit-command information H as information representing the position of the region A1.

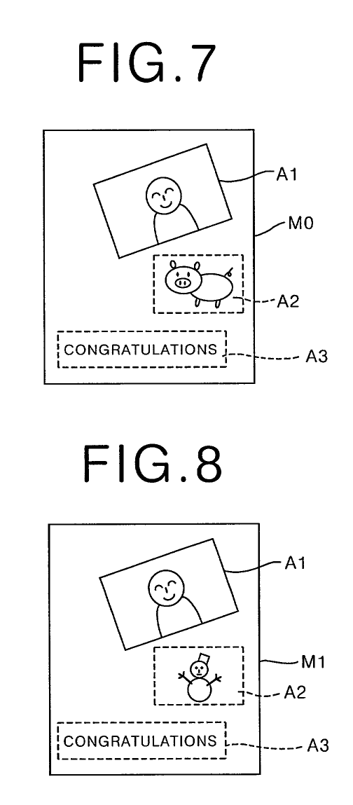

If the laboratory 2 receives the edit-command information H, based on this, in the editing means 7 the region A1 in the template T is rotated and intermediate processed image data M0 is obtained by performing the process of inserting the specified user's image into the region A1 (step S9). Note that while M0, and M1, M2, which are to be described later, are used to denote the intermediate processed image data, in FIG. 1 the data is represented by M. The intermediate processed image data M0 is transferred to the PC 10 (step S10). With this transfer, the intermediate processed image M0 inserting the user's image into the rotated region A1 is displayed on the PC 10 of the user 1, as shown in FIG. 7 (step S11).

It is judged whether or not the editing process has been ended for an editing object desired (step S12). In the first embodiment the editing process has not been ended for regions A2 and A3, so the process returns to step S4 and is repeated from step S4 to step S12. In the case of only a single editing object (e.g., the case of including only a change in the shape of the region A1 and not including other processes), the editing process from step S4 to step S12 is performed only once.

In addition, when there is no change in the sample character in the region A3, for example, there is no need to process all editing objects. Therefore, all that is required is to process only editing objects desired (i.e., only regions A1 and A2).

Next, if an inquiry about an editing object is made for the region A2, the coordinate values representing the range of the region A2 are transferred to the PC 10 as the editing information, as with the above-mentioned region A1. In response to this, the user 1 transfers both the result of a change in the shape of the region A2 and the file name of the clip art to be inserted into the region A2 to the laboratory 2 as the edit-command information H. In the editing means 7 of the laboratory 2, intermediate processed image data M1 is obtained by performing the process of inserting the clip art specified by the user into the changed region A2. The intermediate processed image data M1 is transferred to the PC 10. With this transfer, the intermediate processed image M1 inserting the clip art specified by the user into the region A2 is displayed on the PC 10, as shown in FIG. 8.

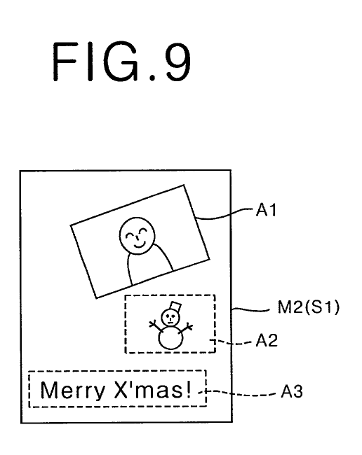

Furthermore, if an inquiry about an editing object is made for the region A3, the coordinate values representing the range of the region A3 are transferred to the PC 10 as the editing information, as with the above-mentioned region A1. In response to this, the user 1 specifies a character string, photo type and size, and character editing (shading or trimming) which are inserted into the region A3. The result of a change in the region A3 and the result of the specification are transferred to the laboratory 2 as the edit-command information H. In the editing means 7 of the laboratory 2, intermediate processed image data M2 is obtained by performing the process of inserting the characters specified by the user into the changed region A3. The intermediate processed image data M2 is transferred to the PC 10. With this transfer, the intermediate processed image M2 inserting the characters specified by the user into the region A3 is displayed on the PC 10, as shown in FIG. 9.

If the editing process ends for an editing object desired, the process advances from step S12 to step S13. In step S13 it is judged whether or not the displayed image is OK. If it is OK, in the laboratory 2 the intermediate processed image data M2 is considered to be processed image data S1, and the processed image data S1 is printed (step S14). In this manner, the editing process ends. On the other hand, if the judgement in step S13 is “NO,” the editing process returns to step S1 to repeat steps S1 through S13. Note that when a change in the displayed intermediate processed image is made after step S11, the editing process may return to step S4 to repeat steps S4 through S11.

Thus, in the first embodiment, the user 1 gives only a command to edit each editing object by use of the PC 10 and transfers the edit-command information H representing the contents of each command to the laboratory 2. Therefore, all that is required is that the PC has only simple software for generating the edit-command information H, and there is no need to prepare the same editor software as the editing means 7 of the laboratory 2. Therefore, as there is no necessity for downloading large-capacity editor software into the PC, burdens to users, such as a communication charge, etc., can be reduced. In addition, since the software which is carried out by the PC 10 is simple, the PC 10 is capable of applying an edit command even if the processing capacity is small. For this reason, portable information terminals, portable telephones, mobile computers, etc., are also capable of applying an edit command. Furthermore, because all that is required is that only the laboratory 2 has the editor software, the need to manage the versions of software being used by all users is eliminated. This can reduce the version management cost for the software company.

It is preferable that in the aforementioned first embodiment, the capacity of data to be transferred be reduced by making resolution lower, increasing compression rate, or reducing the number of colors when transferring editing data C. This will hereinafter be described as a second embodiment of the present invention.

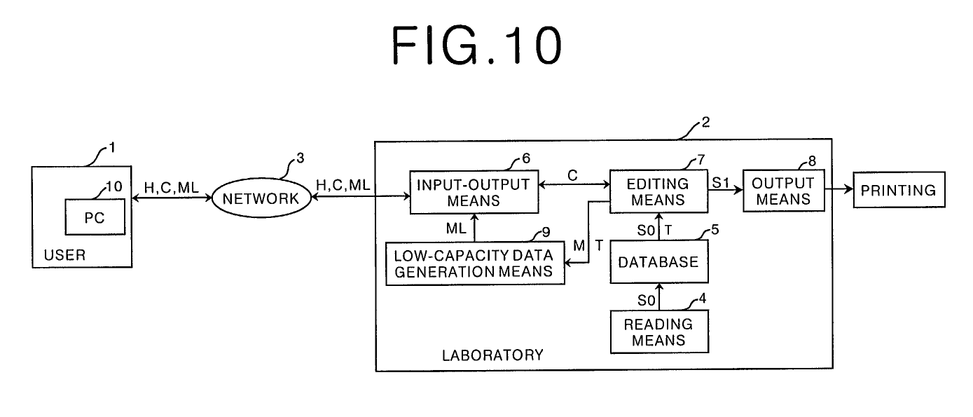

FIG. 10 shows an image editing system constructed according to the second embodiment. In the figure, the same reference numerals are applied to the same parts as FIG. 1 and therefore a detailed description is omitted in order to avoid redundancy. The image editing system shown in FIG. 10 differs from the first embodiment in that it is equipped with low-volume data generation means 9 for generating low-volume data ML.

The low-volume data generation means 9 scales down the template data T, processed image data S1, clip art data, and intermediate processed image data M and generates image data representing these low-resolution images, as low-volume data ML. In the second embodiment, the low-volume data ML is generated in stages from lower resolution to higher resolution. For example, low-volume data ML with 4 different resolutions is generated. For instance, in the case where an image represented by high-resolution image data S0 has 2000×2000 pixels, the low-volume data ML represents images of 4 different resolutions, i.e., an image of 1000×1000 pixels, an image of 500×500 pixels, an image of 250×250 pixels, and an image of 125×125 pixels.

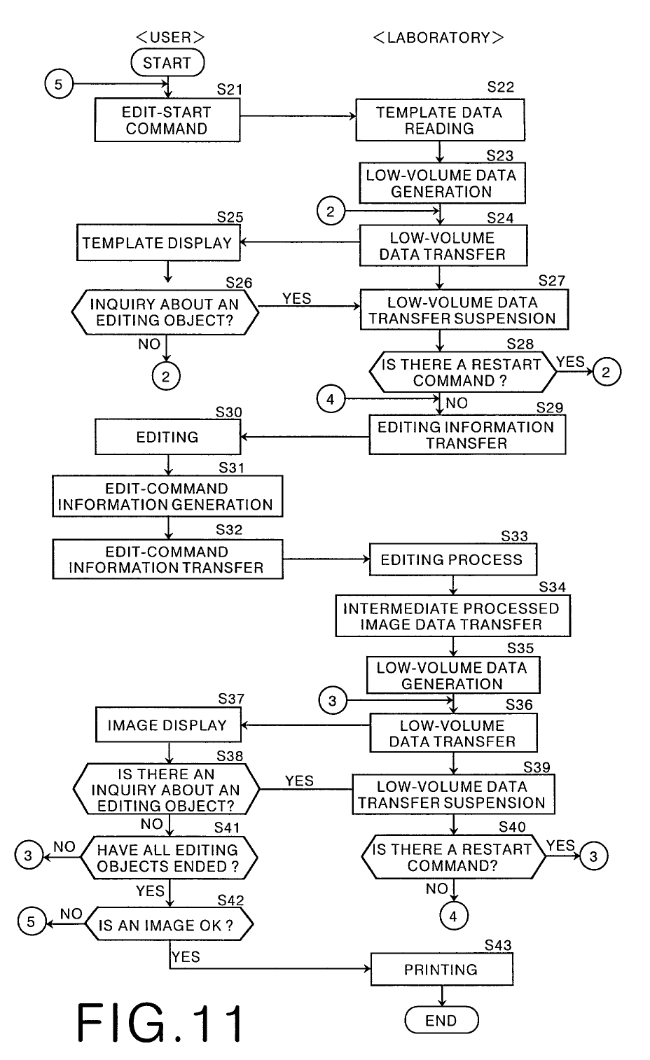

Now, the operation of the second embodiment will be described in detail with reference to FIG. 11. Assume that an image from the user 1 has already been read out by the reading means 4 and archived in the database 5. In the second embodiment, as with the first embodiment, a processed image is obtained by inserting the user's image into the region A1 in the template T, a clip art in the region A2, and characters in the region A3.

First, as with step S1 in the first embodiment, the user 1 transfers a command to start editing of the user's image to the laboratory 2 by the PC 10 (step S21). If the laboratory 2 receives the edit-start command, the editing means 7 reads out the template data T representing the template T from the database 5 (step S22). The template data T is input to the low-volume data generation means 9, in which low-volume data ML for the template data T is generated (step S23). The low-volume data ML is transferred in sequence to the PC 10 through the input-output means 6 from the lower-resolution data (step S24). If receiving the low-volume data ML, the PC 10 displays it in sequence from the lower resolution side (step S25). Then, it is judged whether or not there is an inquiry about an editing object (step S26). If the user 1 confirms the displayed template and queries the laboratory 2 about one of the editing objects, the editing process advances to step S27. On the other hand, if there is no inquiry, the editing process returns to step S24 and the low-volume data ML is again transferred. In the second embodiment, the region A1 is first clicked on.

If receiving the inquiry about an editing object, the laboratory 2 suspends the transfer of the low-volume data ML even if the transfer of the low-volume data of all resolutions has not been completed yet (step S27). Furthermore, it is judged whether or not there is a command to restart data transfer (step S28). If “YES,” the editing process returns to step S24 and the low-volume data ML is again transferred. On the other hand, if “NO,” the editing means 7 transfers editing information, corresponding to the editing object requested by the user 1, to the PC 10 (step S29). If receiving the editing information, the user 1 starts editing the region A1 (step S30). Note that as with the first embodiment, the region A1 is inclined or rotated as shown in FIG. 6.

If editing ends, edit-command information H is generated (step S31). This information H is transferred to the laboratory 2 (step S32). If the laboratory 2 receives the edit-command information H, based on this, in the editing means 7 the region A1 in the template T is inclined and intermediate processed image data M0 is obtained by performing the process of inserting the specified user's image into the region A1 (steps S33 and S34). Note that while M0, and M1, M2, which are to be described later, are used for indicating the intermediate processed image data, in FIG. 10 the data is represented by M. In the low-volume data generation means 9, low-volume data ML for the intermediate processed image data M0 is generated (step S35). The low-volume data ML is transferred in sequence to the PC 10 from the lower resolution data (step S36). With this transfer, the intermediate processed image data M0 inserting the user's image into the rotated region A1 shown in FIG. 7 is displayed on the PC 10 of the user 1 in sequence from the lower resolution side (step S37). Then, it is judged whether or not there is an inquiry about an editing object (step S38). If the user 1 confirms the displayed intermediate processed image data M0 and queries the laboratory 2 about one of the remaining editing objects, the editing process advances to step S39.

If receiving the inquiry about an editing object, the laboratory 2 suspends the transfer of the low-volume data ML even if the transfer of the low-volume data of all resolutions has not been completed yet (step S39). Furthermore, it is judged whether or not there is a command to restart data transfer (step S40). If “YES,” the editing process returns to step S36 and the low-volume data ML is again transferred. On the other hand, if “NO,” the editing process returns to step S29 and the editing means 7 transfers editing information, corresponding to the editing object requested by the user 1, to the PC 10. Based on the editing information, the editing process is repeated from step S29 to step S38.

When the judgement in step S38 is “NO,” it is judged whether or not the editing process has been ended for an editing object desired (step S41). In the second embodiment the editing process has not been ended for regions A2 and A3, so the process returns to step S436 and is repeated from step S36 to step S38. In the case of only a single editing object (e.g., the case of including only a change in the shape of the region A1 and not including other processes), the judgement in step S38 is “NO,” and furthermore, the judgement in step 41 is also “NO,” so the transfer of the intermediate processed image data from the inquiry about an editing object is performed only once.

Next, if an inquiry about an editing object is made for the region A2, the judgement in step S38 is “YES.” Furthermore, if the judgement in step S40 is “NO,” the coordinate values representing the range of the region A2 are transferred to the PC 10 as the editing information, as with the above-mentioned region A1. In response to this, the user 1 transfers both the result of a change in the shape of the region A2 and the file name of the clip art to be inserted into the region A2 to the laboratory 2 as the edit-command information H. In the editing means 7 of the laboratory 2, intermediate processed image data M1 is obtained by inserting the clip art specified by the user into the changed region A2. The low-volume data ML for the intermediate processed image data M1 is generated, and is transferred to the PC 10 from the lower resolution data. With this transfer, the intermediate processed image M1 inserting the clip art specified by the user into the region A2 is displayed on the PC 10, as shown in FIG. 8.

Furthermore, if an inquiry about an editing object is made for the region A3, the judgement in step S38 is “YES.” Furthermore, if the judgement in step S40 is “NO,” the coordinate values representing the range of the region A3 are transferred to the PC 10 as the editing information, as with the above-mentioned region A1. In response to this, the user 1 specifies a character string, photo type and size, and character editing (shading or trimming) which are inserted into the region A3. The result of a change in the shape of the region A3 and the result of the specification are transferred to the laboratory 2 as the edit-command information H. In the editing means 7 of the laboratory 2, intermediate processed image data M2 is obtained by inserting the characters specified by the user into the changed region A3. The low-volume data ML for the intermediate processed image data M1 is generated, and is transferred to the PC 10. With this transfer, the intermediate processed image M2 inserting the characters specified by the user into the region A3 is displayed on the PC 10 in sequence from the lower resolution data, as shown in FIG. 9.

If the editing process ends for an editing object desired, the process advances from step S41 to step S42. In step S42 it is judged whether or not the displayed image is OK. If it is OK, in the laboratory 2 the intermediate processed image data M2 is considered to be processed image data S1, and the processed image data S1 is printed (step S43). In this way, the editing process ends. On the other hand, if the judgement in step S42 is “NO,” the editing process returns to step S21 to repeat steps S21 through S42. Note that when a change in the displayed intermediate processed image is made after step S37, the editing process may return to step S26 to repeat steps S26 through S37.

Thus, in the second embodiment, the low-volume data ML for the template data or intermediate processed image data M is generated and transferred to the PC 10 of the user 1. Therefore, transfer time can be reduced, compared with the case of transferring the template data T or intermediate processed image data M itself.

Also, the low-volume data ML is composed of a plurality of data reduced in stages in data amount and is transferred in sequence from the data smaller in data amount. Therefore, the low-volume data ML is displayed on the PC 10 from the data lower in capacity. The user 1 views the image being displayed in sequence from the lower resolution side and, in the case where the contents can be confirmed even if it has low resolution, is able to suspend the transfer of the low-volume data ML and perform the subsequent process and is therefore able to perform the editing operation efficiently.

In addition, the transfer of the low-volume data ML can be restarted after suspension, so the user 1 can receive the low-volume data ML processed up to a desired stage. Therefore, the user can restart the transfer of the low-volume data ML when he wants to view to the end result.

In the above-mentioned second embodiment, while only the low-volume data ML for the template data T or intermediate processed image data M is transferred to the PC 10, the template data T and the intermediate processed image data M may be transferred, following the transfer of the low-volume data ML. With this transfer, a higher-quality image is to be displayed on the PC 10 of the user 1.

While, in the aforementioned second embodiment, low-resolution data obtained by scaling down the template data T and the intermediate processed image data M is used as the low-volume data ML, the present invention is not limited to this. For example, data with compression rate varying in stages, or data with the number of colors reduced in stages, may be used as the low-volume data ML.

Although, in the aforementioned second embodiment, the amount of the low-volume data ML is varied in stages, the present invention is not limited to this. For instance, single low-volume data may be employed.

In the aforementioned second embodiment, the loaded state of the network 3 may be detected before generation of the low-volume data ML and, according to the loaded state, the amount of the low-volume data ML may be varied. That is, in the case where the load on the network 3 is great, the time to transfer data can be made proper if the capacity of the low-volume data ML is made smaller.

Furthermore, in the aforementioned second embodiment, low-resolution data, which represents a low-resolution image, for user's image data, template data, and clip art data, may be generated as low-capacity data ML, and intermediate processed image data may be obtained by performing image processing, based on an edit command, on the low-capacity data ML. The intermediate processed image data may be transferred to the PC 10 of the user 1. In this case, edit-command information H is archived temporarily in the laboratory 2, and after an editing process, processed image data S1 is obtained based on the archived edit-command information H by use of the image data S0, template data, clip art data of high resolution.

While it has been described that in the aforementioned first and second embodiments, the software for generating edit-command information H has already been installed in the PC 10 of the user 1, this software may be downloaded from the laboratory 2 into the PC 10 of the user by an edit-start command. In this case, this software can employ a Java applet. That is, with the laboratory 2 as a Web server, the user 1 accesses the html file of the laboratory 2 by the Web browser of the PC 10 when performing editing. The Java applet is registered in the laboratory 2 as the software for generating edit-command information and is specified to the html film. Also, assume that the Web browser includes a Java virtual machine. If the user 1 accesses the laboratory 2 using the Web browser and downloads the html file, then the Java applet described in the html file will be downloaded from the laboratory 2, and based on this Java applet, generation of the edit-command information H can be executed.

In addition, a distributed object calling function, such as RMI, CORBA, etc., may be described in the Java applet, and an object method (in this case, a program for performing editing) present on the Java virtual machine in the laboratory 2 may be called up. Furthermore, the software for generating the edit-command information H is not limited to the Java applet, and a program for performing an edit command generated by a language (e.g., a C language, a C++ language, etc.) other than the Java applet may be read out.

Although it has been described that in the aforementioned first and second embodiment, the regions A1 to A3 in the template T are editing objects and a user's image, a clip art, and characters are inserted into these regions A1 to A3, a wide variety of processes, such as a sharpness enhancing process, a color converting process, a red-eye process, etc., in addition to insertion of images and characters, may be performed. In this case, for example, when an inquiry about an editing object is made for the region A1, a list of processes which can be performed in the laboratory 2, in addition to the information representing the range of the region A1, is transferred to the PC 10 as editing information. Based on the list, the user 1 specifies the contents of the process, which are performed on the user's image, and the parameters and transfers them to the laboratory 2 as edit-command information H. With this transfer, in the laboratory 2 the process specified by the edit-command information H can be performed on the user's image. The image processing may also include the process of applying part of the template T a wave pattern, the process of applying the region A1 a white edge, and the process of reflecting a user's image, inserted into the region A1, on another region in the template T.

Although the aforementioned first and second embodiment have been described with reference to the case of performing the editing process of synthesizing a template and a user's image, the present invention is also applicable to the case of performing image processing only on the image data S0. That is, if an edit-start command is transferred to the laboratory 2 in the case where the user's image is subjected to image processing such as a sharpness enhancing process, etc., the laboratory transfers the image data S0 representing the user's image to the PC 10 of the user 1. If receiving the image data S0, the user 1 queries the laboratory 2 about an editing object. In response to this, the laboratory 2 transfers a list of processes, which can be performed on the image data S0, to the PC 10 as editing information. With the list, the user 1 determines the process, which is performed on the image data S0, and the parameters, and transfers them to the laboratory 2 as edit-command information H. Based on the edit-command information H, the laboratory 2 obtains processed image data S1 by performing the specified process on the image data S0, and generates low-volume data for the image data S1. The low-volume data can be transferred to the PC 10.

Note that in the case of performing image processing only on the image data S0, image data with a lower resolution than the image data S0 may be generated in the laboratory 2, and this low-resolution image data may be transferred to the user 1. In this case, the image processing based on the edit-command information H is performed on the low-resolution image data, intermediate processed data with a low resolution is obtained. The edit-command information H is archived in the laboratory 2. After editing, the image data S0 is given the same image process as the image processing performed on the low resolution image data, based on the edit-command information H. In this manner, processed image data S1 can be obtained.

In the aforementioned first and second embodiments, the template T with sample images inserted therein has been transferred to the user 1 as editing data. However, at the same time as an edit-start command, specification of a user's image may be received, and synthesized data of user's image data and template data transferred as editing data.

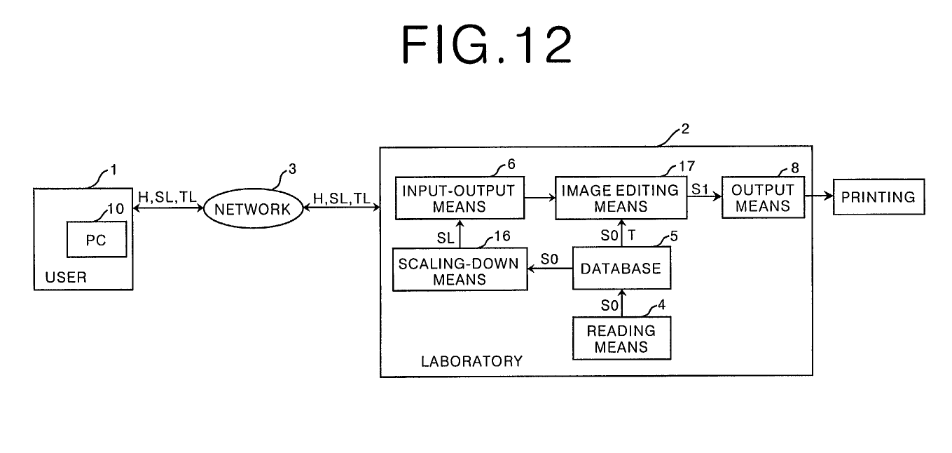

Now, an image editing system according to a third embodiment of the present invention will be described with reference to FIG. 12. In the figure, the same reference numerals are applied to the same parts as FIG. 1 and therefore a detailed description is omitted in order to avoid redundancy. The image editing system shown in FIG. 12 is differentiated from the first embodiment in that it is equipped with scaling-down means 16 for generating low-resolution data for image data S0, and image editing means 17 for obtaining processed image data S1 by editing the image data S0, based on edit-command information H, as with the aforementioned editing means 7.

In the image editing system according to the third embodiment, editor software for performing image editing has been archived in a database 5. Therefore, the user 1 can perform image editing and generation of edit-command information H at a PC 10, by accessing a laboratory 2 and downloading the editor software. This editor software may be recorded on a storage medium such as a CD-R, etc., and provided to the user 1. As with the aforementioned first and second embodiment, template data T has been archived in the database 5. However, the template data T that is transferred to the user 1 is low-resolution template data TL scaled down from the original template data. Also in the third embodiment, a user's image and template data are synthesized.

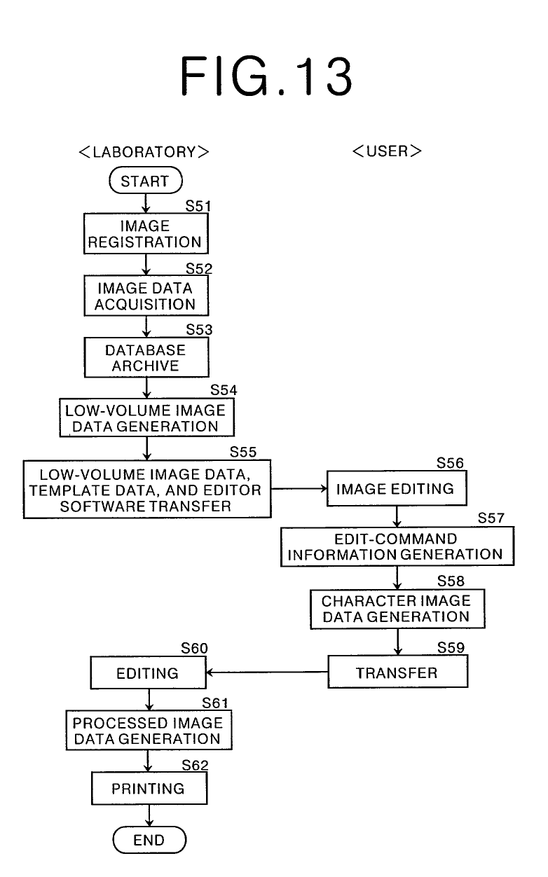

Now, the operation of the third embodiment will be described with reference to FIG. 13. First, the user 1 takes film directly into the laboratory 2 and performs image registration (step S51). In the laboratory 2, the film received from the user 1 is read out by reading means 4, and high-resolution image data S0 representing the image recorded on the film is acquired (step S52). The high-resolution image data S0 is archived in the database 5 (step S53). On the other hand, in the scaling-down means 16, low-resolution image data SL lower in resolution than the high-resolution image data So is generated (step S54). In response to a command from the PC 10 of the user 1, the low-resolution image data SL, the template data TL, and the editor software are transferred to the PC 10 of the user 1 through a network 3 (step S55).

Here, if the PC 10 requests the laboratory 2 to transfer a URL for transfer of the low-resolution image data SL and the template data TL, for image editing, the laboratory 2 transfers a html file to the PC 10. Note that the Java applet for downloading the editor software may be registered in the laboratory 2, and in the html file, the Java applet may be specified. Also, at the same time as downloading of the html file, transfer of the editor software may be received. With this html film and an active-X component installed in the PC 10 of the user 1, the editor software maybe downloaded. Furthermore, a distributed object function, such as RMI, CORBA, etc., may be described in the Java applet and this Java applet specified in the html file. In this case, by letting the laboratory 2 have the function of editing the low-resolution image data SL, the PC 10 can be set so that it performs only an edit command. Therefore, the user 1 can perform image editing by use of the Web browser at the PC 10 without receiving the editor software.

Note that in the case where the editor software has been recorded on a storage medium and provided, or in the case where the editor software has already been installed in the PC 10, only the low-resolution image data SL and template data TL are transferred.

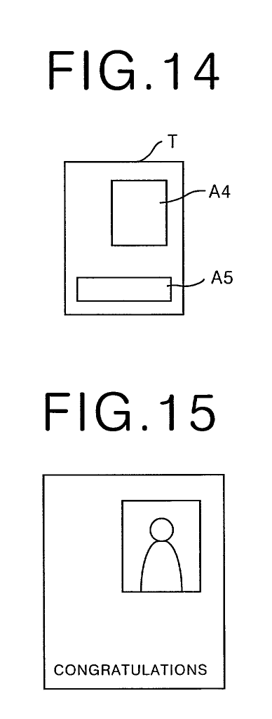

If the transfer of the low-resolution image data SL, the template data TL, and the editor software is completed, the user 1 installs the editor software, starts this and displays the low-resolution image data SL and the template data TL on the monitor of the PC 10, and performs image editing (step S56) This image editing is the process of synthesizing a template and a user's image. The user's image is inserted into the region A4 in the template T shown in FIG. 14, and the characters desired by the user 1 are inserted into the region A5 with a predetermined font and a predetermined layout. With this operation, an edited low-resolution image with the user's image and characters inserted therein is generated as shown in FIG. 15.

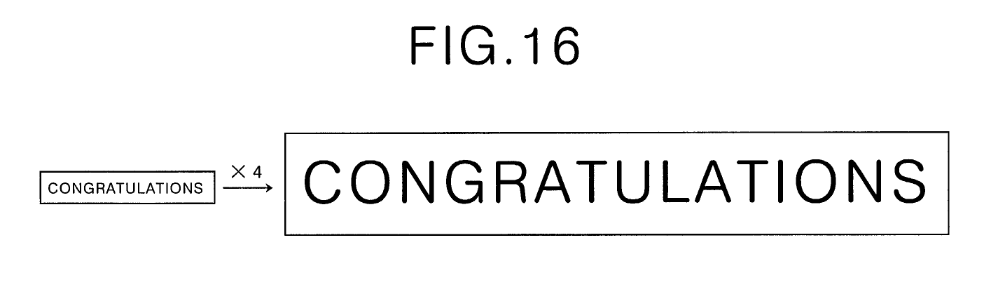

If editing is completed, edit-command information H is generated (step S57) and character image data M representing the characters inserted into the region A5 is generated (step S58). Although the character image data M represents the characters inserted into the region A5 in the template, the resolution is generated so that it becomes the same as the image data and template T archived in the database 5 of the laboratory 2. For instance, in the case where the resolution of the low-resolution image data SL is one-fourth the image data S0, the character image data M is generated so that it has 4 times the resolution of the characters inserted into the region A5, as shown in FIG. 16. If the character image data M is generated in this manner, the edit-command information H and the character image data M are transferred to the laboratory 2 (step S59).

In the laboratory 2, the edit-command information H and the character image data Mare received by input-output means 6, and based on the edit command, the high-resolution image data S0 and the template data T are read out from the database 5. Based on the edit-command information H, image editing means 17 performs the process of synthesizing the image data S0 and the template data T, and also performs the process of inserting characters based on the character image data M (step S60), whereby processed image data S1 is generated (step S61) Then, the processed image data S1 is printed by output means 8 (step S62), and the editing process ends. The printed image is provided to the user 1.

Thus, according to the third embodiment, the user 1 generates the character image data M and transfers this to the laboratory 2, and in the laboratory 2, the processed image data S1 is generated by employing this character image data M. Therefore, even if the laboratory 2 does not have fonts desired by the user 1, characters generated with the desired font can be included in a printed image, and consequently, editing with a high degree of freedom can be performed.

The aforementioned third embodiment has been described with reference to the case of inserting characters into the template T. However, in the case where characters are simply inserted into an image without using the template T, the edit-command information H will contain α-channel information representing the relationship of transparency between a user's image and a character image.

Also, while the aforementioned third embodiment has been described with reference to the case where the image data S0 and the template T, archived in the laboratory 2, are synthesized and characters are inserted, images that the user 1 has may also be used for generating a printed image. In this case, the image data that the user 1 has, in addition to the edit-command information H and the character image data M, need to be transferred to the laboratory 2.

Although it has been described in the aforementioned embodiments that the template data T, the clip art data, and the image data S0 on a user's image are archived in the database 5, they may be archived in the PC 10 of the user 1, and when editing is performed, they may be transferred from the PC 10 of the user 1 to the laboratory 2.

In addition, all of the contents of Japanese Patent Application Nos. 2000-007272, 2000-007273, 2000-027965, 2000-399715 and 2000-399716 are incorporated into this specification by reference.

What is claimed is:

1. An image editing method that is performed in an image editing system equipped with a client, which has an edit-command unit for applying a command to edit image data, and an image server, connected with said client through a network, which has an editing unit for obtaining processed image data by editing said image data in response to the edit command from said edit-command unit, said image editing method comprising:
a first step of accepting an edit-start command and, in response to said edit-start command, commanding said image server to transfer editing data, having at least one editing object, which contains said image data, at said edit-command unit, and of transferring said editing data to said client at said image server;
a second step of querying said image server about one editing object for obtaining said processed image data in accordance with said editing data, at said edit-command unit;
a third step of transferring editing information, which represents said one editing object corresponding to said inquiry, to said client, at said editing unit;
a fourth step of generating edit-command information which represents a command to edit said editing object, in accordance with said editing information and also transferring said edit-command information to said image server, at said edit-command unit;
a fifth step of obtaining intermediate processed image data by applying an editing process to said editing data in accordance with said edit-command information and also transferring said intermediate processed image data to said client, at said editing unit; and
a sixth step of repeating said second through the fifth steps, until said edit-command information is transferred for an editing object desired and said processed image data is obtained.

2. An image editing system comprising:
a client having an edit-command unit for applying a command to edit image data;
an image server, connected with said client through a network, which has an editing unit for obtaining processed image data by editing said image data in response to the edit command from said edit-command unit;
said edit-command unit having first means for accepting an edit-start command and, in response to said edit-start command, commanding said image server to transfer editing data, having at least one editing object, which contains said image data; second means for querying said image server about one editing object for obtaining said processed image data, based on said editing data transferred from said image server in accordance with said command to transfer said editing data; and third means for generating edit-command information which represents a command to edit said editing object, based on said editing information transferred from said image server in accordance with said inquiry about said editing object, and for transferring said edit-command information to said image server;
said editing unit having first means for transferring said editing data to said client in response to said command to transfer said editing data; second means for transferring editing information, which represents an editing object corresponding to said inquiry, to said client; and third means for obtaining intermediate processed image data by applying an editing process to said editing data, based on said edit-command information, and for transferring said intermediate processed image data to said client; and
means for repeatedly carrying out the steps carried out in the second and third means of said edit-command unit and the first, second, and third means of said editing unit, until said edit-command information is transferred for an editing object desired and said processed image data is obtained.

3. A computer readable storage medium recording a program for causing a computer to carry out the image editing method as set forth in claim 1, wherein said program has
a first procedure of accepting an edit-start command and, in response to said edit-start command, commanding said image server to transfer editing data, having at least one editing object, which contains said image data;
a second procedure of querying said image server about one editing object for obtaining said processed image data, based on said editing data transferred from said image server in accordance with said command to transfer said editing data;
a third procedure of generating edit-command information which represents a command to edit said editing object, based on said editing information transferred from said image server in accordance with said inquiry about said editing object, and of transferring said edit-command information to said image server; and
a fourth procedure of repeating said second and third procedures, until said edit-command information is transferred for an editing object desired and said processed image data is obtained.

4. A computer readable storage medium recording a program for causing a computer to carry out the image editing method as set forth in claim 1, wherein said program has
a first procedure of transferring said editing data to said client in response to said command to transfer said editing data;
a second procedure of transferring editing information, which represents an editing object corresponding to said inquiry, to said client;
a third procedure of obtaining intermediate processed image data by applying an editing process to said editing data, based on said edit-command information, and of transferring said intermediate processed image data to said client; and
a fourth procedure of repeating said first, second, and third procedures, until said edit-command information is transferred for an editing object desired and said processed image data is obtained.

5. An edit-command unit in an image editing system equipped with a client, which has said edit-command unit for applying a command to edit image data, and an image server, connected with said client through a network, which has an editing unit for obtaining processed image data by editing said image data in response to the edit command from said edit-command unit, said edit-command unit comprising:
first means for accepting an edit-start command and, in response to said edit-start command, commanding said image server to transfer editing data, having at least one editing object, which contains said image data;
second means for querying said image server about one editing object for obtaining said processed image data, based on said editing data transferred from said image server in accordance with said command to transfer said editing data;
third means for generating edit-command information which represents a command to edit said editing object, based on said editing information transferred from said image server in accordance with said inquiry about said editing object, and for transferring said edit-command information to said image server; and
fourth means for repeatedly carrying out the steps carried out in said second and third means, until said edit-command information is transferred for an editing object desired and said processed image data is obtained.

6. An editing unit in an image editing system equipped with a client, which has an edit-command unit for giving a command to edit image data, and an image server, connected with said client through a network, which has said editing unit for obtaining processed image data by editing said image data in response to the edit command from said edit-command unit, said editing unit comprising:
first means for transferring said editing data to said client in response to said command to transfer said editing data;
second means for transferring editing information, which represents an editing object corresponding to said inquiry, to said client;
third means for obtaining intermediate processed image data by applying an editing process to said editing data, based on said edit-command information, and for transferring said intermediate processed image data to said client; and
fourth means for repeatedly carrying out the steps carried out in said first, second, and third means, until said edit-command information is transferred for an editing object desired and said processed image data is obtained.

7. An image editing method that is performed in an image editing system equipped with a client, which has an edit-command unit for giving a command to edit image data, and an image server, connected with said client through a network, which has an editing unit for obtaining processed image data by performing an editing process on said image data in response to the edit command from said edit-command unit and transfers predetermined image data related to said image data to said client, said image editing method comprising the steps of:
generating low-volume data smaller in data amount than said predetermined image data; and
transferring said low-volume data to said client.

8. The image editing method as set forth in claim 7, wherein said predetermined image data is any one among image data before said editing process is applied, image data subjected to an editing process up to an intermediate stage, and said processed image data.

9. The image editing method as set forth in claim 7, wherein said predetermined image data is transferred to said client, following said low-volume data.

10. The image editing method as set forth in claim 8, wherein said predetermined image data is transferred to said client, following said low-volume data.

11. The image editing method as set forth in claim 7, wherein the data amount of said low-volume data is varied according to a loaded state of said network.

12. The image editing method as set forth in claim 8, wherein the data amount of said low-volume data is varied according to a loaded state of said network.

13. The image editing method as set forth in claim 9, wherein the data amount of said low-volume data is varied according to a loaded state of said network.

14. The image editing method as set forth in claim 7, wherein said low-volume data is composed of a plurality of data reduced in stages in data amount and is transferred to said client from the data smaller in data amount.

15. The image editing method as set forth in claim 8, wherein said low-volume data is composed of a plurality of data reduced in stages in data amount and is transferred to said client from the data smaller in data amount.

16. The image editing method as set forth in claim 9, wherein said low-volume data is composed of a plurality of data reduced in stages in data amount and is transferred to said client from the data smaller in data amount.

17. The image editing method as set forth in claim 11, wherein said low-volume data is composed of a plurality of data reduced in stages in data amount and is transferred to said client from the data smaller in data amount.

18. The image editing method as set forth in claim 14, wherein transfer of said low-volume data is suspended in response to a command from said client.

19. The image editing method as set forth in claim 18, wherein transfer of said low-volume data is restarted in response to a command from said client.

20. An image editing system comprising:
a client having an edit-command unit for giving a command to edit image data;
an image server, connected with said client through a network, which has an editing unit for obtaining processed image data by performing an editing process on said image data in response to the edit command from said edit-command unit and transfers predetermined image data related to said image data to said client;
wherein said image server has means for generating low-volume data smaller in data amount than said predetermined image data, and transfers said low-volume data to said client.

21. The image editing system as set forth in claim 14, wherein said predetermined image data is any one among image data before said editing process is applied, image data subjected to an editing process up to an intermediate stage, and said processed image data.

22. The image editing system as set forth in claim 20, wherein said image server is further equipped with means for transferring said predetermined image data to said client, following said low-volume data.

23. The image editing system as set forth in claim 21, wherein said image server is further equipped with means for transferring said predetermined image data to said client, following said low-volume data.

24. The image editing system as set forth in claim 20, wherein said image server is further equipped with means for varying the data amount of said low-volume data according to a loaded state of said network.

25. The image editing system as set forth in claim 21, wherein said image server is further equipped with means for varying the data amount of said low-volume data according to a loaded state of said network.

26. The image editing system as set forth in claim 22, wherein said image server is further equipped with means for varying the data amount of said low-volume data according to a loaded state of said network.

27. The image editing system as set forth in claim 20, wherein said means for generating low-volume data is means for generating said low-volume data so that it is composed of a plurality of data reduced in stages in data amount, and transfers said low-volume data to said client in sequence from the data having a smaller data amount.

28. The image editing system as set forth in claim 21, wherein said means for generating low-volume data is means for generating said low-volume data so that it is composed of a plurality of data reduced in stages in data amount, and transfers said low-volume data to said client in sequence from the data having a smaller data amount.

29. The image editing system as set forth in claim 22, wherein said means for generating low-volume data is means for generating said low-volume data so that it is composed of a plurality of data reduced in stages in data amount, and transfers said low-volume data to said client in sequence from the data having a smaller data amount.

30. The image editing system as set forth in claim 24, wherein said means for generating low-volume data is means for generating said low-volume data so that it is composed of a plurality of data reduced in stages in data amount, and transfers said low-volume data to said client in sequence from the data smaller in data amount.

31. The image editing system as set forth in claim 27, wherein said image server is further equipped with means for suspending transfer of said low-volume data in response to a command from said client.

32. The image editing system as set forth in claim 31, wherein said image server is further equipped with means for restarting transfer of said low-volume data in response to a command from said client.

33. A computer readable storage medium recording a program for causing a computer to carry out the image editing method as set forth in claim 7, wherein said program has
a procedure of generating low-volume data smaller in data amount than said predetermined image data; and
a procedure of transfers said low-volume data to said client.

34. The computer readable storage medium asset forth in claim 33, wherein said predetermined image data is any one among image data before said editing process is applied, image data subjected to an editing process up to an intermediate stage, and said processed image data.

35. The computer readable storage medium asset forth in claim 33, wherein said program further has a procedure of transferring said predetermined image data to said client, following said low-volume data.

36. The computer readable storage medium as set forth in claim 34, wherein said program further has a procedure of transferring said predetermined image data to said client, following said low-volume data.

37. The computer readable storage medium as set forth in claim 33, wherein said program further has a procedure of varying the data amount of said low-volume data according to a loaded state of said network.

38. The computer readable storage medium as set forth in claim 34, wherein said program further has a procedure of varying the data amount of said low-volume data according to a loaded state of said network.

39. The computer readable storage medium as set forth in claim 35, wherein said program further has a procedure of varying the data amount of said low-volume data according to a loaded state of said network.

40. The computer readable storage medium as set forth in claim 33, wherein said low-volume data is composed of a plurality of data reduced in stages in data amount, and said procedure of transferring low-volume data is a procedure of transferring said low-volume data to said client in sequence from the data having a smaller data amount.

41. The computer readable storage medium as set forth in claim 34, wherein said low-volume data is composed of a plurality of data reduced in stages in data amount, and said procedure of transferring low-volume data is a procedure of transferring said low-volume data to said client in sequence from the data smaller in data amount.

42. The computer readable storage medium as set forth in claim 35, wherein said low-volume data is composed of a plurality of data reduced in stages in data amount, and said procedure of transferring low-volume data is a procedure of transferring said low-volume data to said client in sequence from the data smaller in data amount.

43. The computer readable storage medium as set forth in claim 37, wherein said low-volume data is composed of a plurality of data reduced in stages in data amount, and said procedure of transferring low-volume data is a procedure of transferring said low-volume data to said client in sequence from the data having a smaller data amount.

44. The computer readable storage medium as set forth in claim 40, wherein said program further has a procedure of suspending transfer of said low-volume data in response to a command from said client.

45. The computer readable storage medium asset forth in claim 44, wherein said program further has a procedure of restarting transfer of said low-volume data in response to a command from said client.

46. An image editing system comprising:
a client having an image-editing command unit for applying a command to edit image data representing a user's image; and
a server, connected with said client through a network, which has means for archiving said image data and low-resolution image data scaled down from said image data and edits said image data;
editing information required for editing said image data which contains said low-resolution image data being transferred from said server to said client;
an operation of editing said low-resolution image data being performed at said client;
the result of editing being transferred to said server as edit-command information;
processed image data being obtained by editing said image data according to said edit-command information at said server;
wherein, when giving a command to insert a character image, which represents characters, into said user's image, said image-editing command unit generates character image data representing a character image of the approximately the same resolution as said user's image and transfers said character image data and said edit-command information to said server; and
said image editing unit obtains said processed image data by inserting said character image into said user's image, based on said edit-command information and said character image data.

47. An image-editing command unit of an image editing system, equipped with a client having said image-editing command unit for applying a command to edit image data representing a user's image and a server which is connected with said client through a network and has means for archiving said image data and low-resolution image data scaled down from said image data and edits said image data, in which editing information required for editing said image data which contains said low-resolution image data is transferred from said server to said client, an operation of editing said low-resolution image data is performed at said client, the result of editing is transferred to said server as edit-command information, and processed image data is obtained by editing said image data according to said edit-command information at said server,
the image-editing command unit comprising means which, when giving a command to insert a character image, which represents characters, into said user's image, generates character image data representing a character image of the approximately the same resolution as said user's image and transfers said character image data and said edit-command information to said server.

48. An image editing unit for editing image data in accordance with the edit-command information obtained in the image-editing command unit as set forth in claim 47, said image editing unit comprising means for obtaining processed image data by inserting a character image into a user's image, based on said edit-command information and character image data.

49. An image-editing command method in an image editing system, equipped with a client having an image-editing command unit for applying a command to edit image data representing a user's image and a server which is connected with said client through a network and has means for archiving said image data and low-resolution image data scaled down from said image data and edits said image data, in which editing information required for editing said image data which contains said low-resolution image data is transferred from said server to said client, an operation of editing said low-resolution image data is performed at said client, the result of editing is transferred to said server as edit-command information, and processed image data is obtained by editing said image data according to said edit-command information at said server;
the image-editing command method comprising the steps of, when giving a command to insert a character image, which represents characters, into said user's image, generating character image data representing a character image of the approximately the same resolution as said user's image, and transferring said character image data and said edit-command information to said server.

50. An image editing method of editing image data in accordance with the edit-command information obtained in the image-editing command method as set forth in claim 49, said image editing method comprising the step of obtaining processed image data by inserting a character image into a user's image in accordance with said edit-command information and character image data.

51. In a computer readable storage medium, recording a program for causing a computer to carry out an image-editing command method, in an image editing system, equipped with a client having an image-editing command unit for applying a command to edit image data representing a user's image and a server which is connected with said client through a network and has means for archiving said image data and low-resolution image data scaled down from said image data and edits said image data, in which editing information required for editing said image data which contains said low-resolution image data is transferred from said server to said client, an operation of editing said low-resolution image data is performed at said client, the result of editing is transferred to said server as edit-command information, and processed image data is obtained by editing said image data according to said edit-command information at said server,
the computer readable storage medium wherein said program has the procedures of, when giving a command to insert a character image, which represents characters, into said user's image, generating character image data representing a character image of the approximately the same resolution as said user's image, and transferring said character image data and said edit-command information to said server.

52. A computer readable storage medium recording a program for causing a computer to carry out a method of editing image data in accordance with the edit-command information obtained in the image-editing command method as set forth in claim 49, wherein said program has a procedure of obtaining processed image data by inserting a character image into a user's image in accordance with said edit-command information and character image data.
